(19) United States
(12) Patent Application Publication
(10) Pub. No.: US 2008/0118214 A1
(43) Pub. Date: May 22, 2008

(54) Optical fiber for detecting stress and associated method

(76) Inventor: Peng Chen, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/717,822

(22) Filed: Mar. 14, 2007

Related U.S. Application Data
(60) Provisional application No. 60/793,606, filed on Apr. 20, 2006.

(51) Int. Cl. G02B 6/036; H04N 5/91; G01B 11/16

(52) U.S. Cl. 385/128; 385/123; 356/32

(57) ABSTRACT

This invention discloses an optical fiber structured to measure stress. The optical fiber includes a core, substantially surrounding the core is a cladding having a plurality of air holes, substantially surrounding the cladding is a buffer, and substantially surrounding the buffer is a jacket.

### BACKGROUND OF THE INVENTION

1. Field of the Invention

This invention relates generally to optical fibers and, more particularly, to optical fibers that are structured to measure a 3-D stress distribution in a structure.

2. Description of the Prior Art

In optical fibers, fiber Bragg gratings are essential for optical communication and sensing. One drawback, however, to optical fibers having fiber Bragg gratings is that they are limited to measuring (sensing) stress and vibration in only one dimension (i.e. along the axial dimension of the fiber component) since the mechanical and thermal properties of silica glasses inhibit the fiber's ability to measure transverse stresses.

### SUMMARY OF THE INVENTION

It would be desirable, therefore, to provide an improved optical fiber having the capability of measuring stresses in more than one dimension.

This invention discloses an optical fiber having an elongated core that is substantially surrounded by a cladding, which is in contact with an exterior surface of the core, having a plurality of longitudinal air holes.

This invention also discloses an optical fiber having an elongated core that is substantially surrounded by a cladding, which is in contact with an exterior surface of the core, having a plurality of longitudinal air holes. The cladding is substantially surrounded by a buffer, which is in contact with an exterior surface of the cladding, and the buffer is substantially surrounded by a jacket, which is in contact with an exterior surface of the buffer.

This invention also discloses a method of making an optical fiber that is capable of measuring a transverse stress. The method includes: providing an elongated core; surrounding the core with a cladding having a plurality of longitudinal air holes; surrounding the cladding with a buffer; and surrounding the buffer with a jacket.

This invention also discloses a method of detecting transverse stress in an optical fiber. The method includes: providing a optical fiber having an elongated core, substantially surrounding the core is a cladding having a plurality of longitudinal air holes, substantially surrounding the cladding is a buffer, and substantially surrounding the buffer is a jacket; coupling an ASE light source to the fiber; coupling an OSA to the fiber; transmitting light from the ASE to the OSA; and employing the transmitted light to measure the transverse stress.

This invention also discloses an optical fiber capable of measuring a 3-D stress distribution in a structure having an elongated core that is substantially surrounded by a cladding, which is in contact with an exterior surface of the core, having a plurality of longitudinal air holes. The cladding is substantially surrounded by a buffer, which is in contact with an exterior surface of the cladding, and the buffer is substantially surrounded by a jacket, which is in contact with an exterior surface of the buffer.

One object of the present invention is to provide an improved optical fiber having the capability of measuring stresses in more than one dimension and a method of making such a fiber.

Another object of the present invention is to provide a method of measuring transverse stress in an optical fiber.

Another object of the present invention is to provide an optical fiber that is capable of measuring 3-D stress distribution in a structure.

Another object of the present invention is to provide an optical fiber that is immune to external strain and impact.

### BRIEF DESCRIPTION OF THE DRAWINGS

FIG. 1 is an isometric view depicting one embodiment in accordance with the invention;

FIGS. 2a and 2b is a stress distribution chart depicting the stresses on a solid fiber as well as an embodiment of the invention when an external transverse load is applied to the fibers;

FIGS. 3a and 3b depict the stress distribution of a first fiber having two air holes oriented substantially perpendicular to the force being applied to the fiber and a second fiber having two air holes oriented substantially parallel to the force being applied to the fiber; and

FIG. 4 depicts the reflected spectra of an FBG in an optical fiber having two air holes when a transverse external load was applied to the optical fiber.

### DESCRIPTION OF THE PREFERRED EMBODIMENTS

As employed herein, the term “longitudinal” and variations thereof refer to an orientation that extends substantially along the axial dimension (i.e. length) of the optical fiber.

As employed herein, the term “transverse” and variations thereof refer to an orientation that extends substantially perpendicular to the axial dimension of the optical fiber.

As employed herein, the term “ASE” refers to an amplified-spontaneous emission light source.

As employed herein, the term “OSA” refers to an optical spectrum analyzer.

As employed herein, the term “FBG” refers to fiber Bragg gratings.

As employed herein, the measurement “N/cm” refers to Newton(s) per centimeter.

As employed herein, the term “3-D stress” refers to stress along the axial direction of an optical fiber and/or a structure as well the two directions perpendicular to the axial direction of the optical fiber and/or structure.

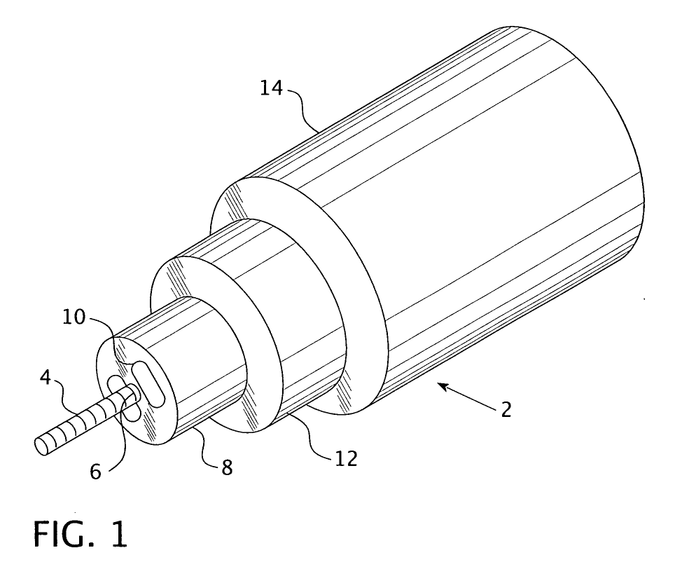

FIG. 1 depicts one embodiment of the optical fiber 2 disclosed in this invention. At the very center of the optical fiber 2 is the core 4, which transmits light though the optical fiber 2. As is known in the art, the core 4 is typically manufactured from silica and can include one or more glass fibers. The core 4, however, may also be manufactured from other materials such as, but not limited to, fluorozirconate, fluoroaluminate, chalcogenide glasses, and polymer materials. In the embodiment that is depicted in FIG. 1, fiber Bragg gratings 6 are etched into the surface of the core 4. Surrounding the core 4 is a cladding 8. The cladding 8 can be manufactured from materials including, but not limited to, polymers, flourine, boron, phosopher-doped silica glass, and chalcogenide glasses. In the embodiment depicted in FIG. 1, the cladding 8 includes a plurality of air holes 10 that extend substantially parallel to an axis, such as the longitudinal axis, of the optical fiber. As will be described in greater hereafter, the air holes 10 are essential to the optical fiber's 2 ability to measure stresses in the transverse direction. Surrounding the cladding 8 is a buffer 12 manufactured from a polymer material. Surrounding the buffer 12 is a jacket 14, which is typically manufactured from polyethylene. The core 4, cladding 8, buffer 12, and jacket 14 are assembled to establish a unitary structure (i.e. the optical fiber 2). In other embodiments of the optical fiber 2, the optical fiber 2 can also include a water blocking layer, such as a carbon coating layer, and an armoring layer, which can be manufactured from a metal or a metal alloy.

### Example 1

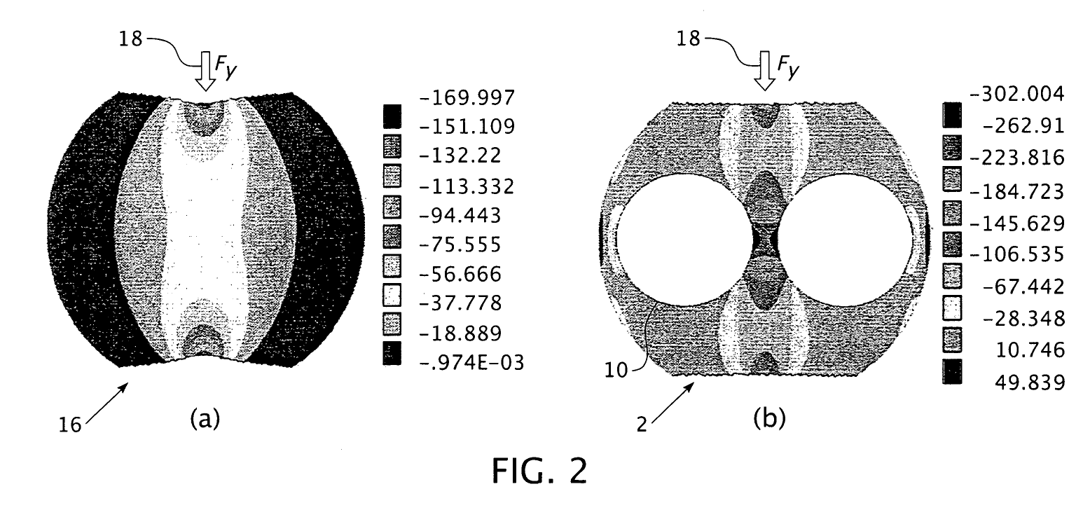

FIG. 2a depicts the stress distribution on a solid fiber 16 (i.e. an optical fiber that does not have an air hole 10) when an external transverse load 18 was applied vertically to the solid fiber 16. In this particular example, prior to application of the transverse load 18 the solid fiber 16 had a diameter of about 220 μm. The external transverse load 18 that was applied to the solid fiber 16 was about 80 N/cm. The maximum stress, as can be seen from FIG. 2a, occurred at the location where the transverse load 18 came into contact with the solid fiber 16 (point of contact) as well as the surrounding vicinity. In the vicinity surrounding the core 4, the stress was dispersed across the entire diameter of the solid fiber 16 as the area of the solid fiber's 16 center (reaction area) increased. Accordingly, the sensitivity of the solid fiber 16 to transverse stress is dramatically reduced due to the increase in area of the solid fiber's 16 center.

Since the stress on the optical fiber 2 is measured by pressure per unit area, the sensitivity of the optical fiber 2 to transverse stresses can be increased by reducing the reaction area. This is achieved by introducing one or more air holes 10 into the optical fiber 2. FIG. 2b, like FIG. 2a, depicts the stress distribution on an optical fiber 2 having a diameter of about 220 μm when an external transverse load 18 of about 80 N/cm was applied to the optical fiber 2. Unlike FIG. 2a, however, the optical fiber 2 in FIG. 2b had two air holes 10 that extended along an axis of the optical fiber 2. As can be seen from FIG. 2b, the two air holes 10 reduced the reaction around the center of the optical fiber 2 thereby focusing the stress directly into the core 4 of the optical fiber 2. In fact, when compared to the solid fiber 16, the compression stress in the center of the optical fiber 2 having the air holes 10 was eight times (8×) greater than the compression stress found at the center of the solid fiber 16.

### Example 2

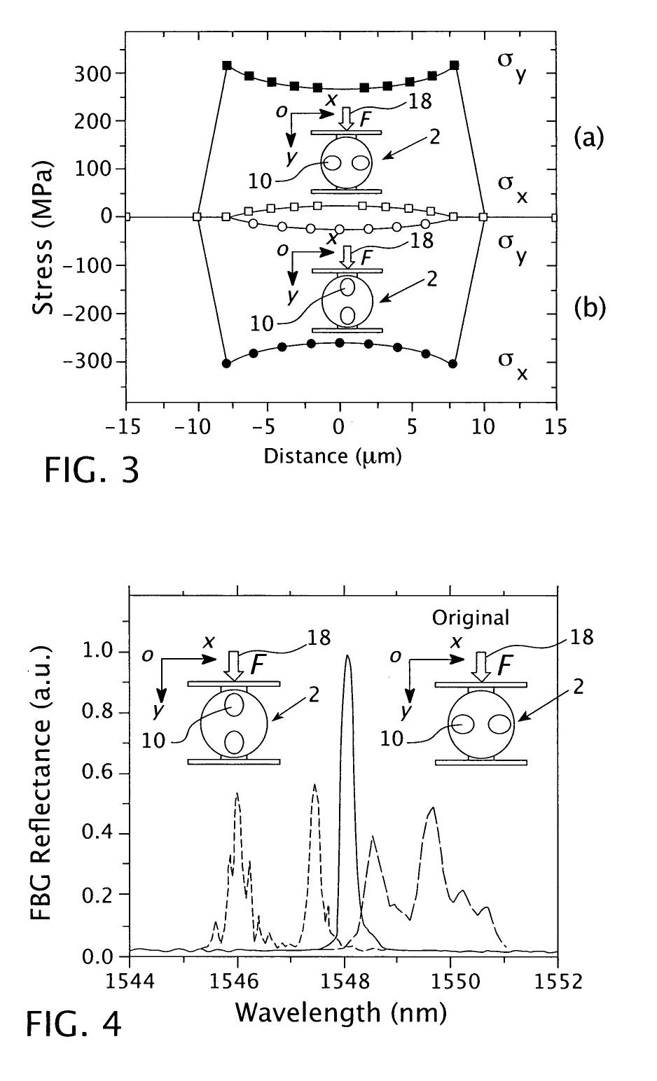

The introduction of air holes 10 into an optical fiber 2 also alternates the symmetry of the fiber thereby enabling the optical fiber 2 to detect an external load in an orientation sensitive manner. Referring to FIG. 3(a), when two air holes 10 are oriented substantially perpendicular to an external load 18 of about 80 N/cm, the load 18 produced compression stress along both the x and y directions. This is in contrast to a tensile stress that was produced by the load 18 when two air holes 10 are substantially parallel to the force (see FIG. 3(b)). The dominate stress along a major axis of the fiber 2 in both fiber orientations are approximately ten times (10×) larger than in the minor axis, which will lead to a significant birefringence in the optical fiber's 2 core 4. FIGS. 3a and 3b also indicate that the maximum stress is produced on the edge of the air holes 10 due to a large deformation around the air hole 10 area. Therefore, to maximize FBG sensitivity, the core 4 of the optical fiber 2 should be placed immediately adjacent (i.e. right beside) at least one air hole 10.

### Example 3

When at least one FBG is inscribed in the core 4 of the optical fiber 2, the orientation dependent stress can be measured by the relative shift of FBG peaks and the peak splits.

A optical fiber 2 (hereafter referred to as “fiber”) having a diameter of about 220 μm and two air holes 10 each having a diameter of about 90 μm was provided. The two air holes 10 were drilled into fiber perform using an ultrasonic driller. The air holes 10 extended in length as the fiber 2 was drawn. An elliptical core 4 with a long axis of about 9.7 μm and a short axis of about 7.5 μm was fabricated about 1 μm off the edge of one of the air holes 10 in order to maximize the fiber's 2 ability to detect and measure stress. In other words, the closer the fiber core 4 is to the edge of the air hole 10 the greater the core's sensitivity to a transverse load. The outer edge of each of the air holes 10 was about 10 μm from the outer edge of the fiber. 1 cm FBGs were etched onto the core 4 of the fiber using a 248 nm (nanometer) KrF excimer laser using a standard phase mask technique. After the FBG inscription, the fiber was thermally annealed at about 120° C. (248° F.) for about 48 hours. The fiber was then mounted on a rotational stage to adjust the orientation of the two air holes 10 to an external load. The orientation of the air hole 10 was monitored by a CCD microscope mounted at one end of the fiber. The fiber and a dummy fiber were mounted between two flat and polished metal plates (i.e. between a top plate and a bottom plate) and the transverse stress was applied by a spring loading apparatus, which was monitored by a load cell that was positioned underneath the bottom plate. The length of the fiber that was subjected to the force was about 80 mm. A broadband ASE light source, an OSA, and a single mode fiber coupler were used to monitor the reflection peak and split of the FBGs.

The reflected spectra of the FBG under an external load are depicted in FIG. 4. When the two air holes are oriented substantially perpendicular to an external load 18 of about 80 N/cm, the FBG peaks shifted to short wavelength and produced a 1.7 nm split. When the two air holes 10 are oriented substantially parallel to an external load 18 of about 80 N/cm, a red shift of the FBG peak and a 1.2 nm peak split was produced due to the induced birefringence, which is caused by the transverse stress. The data depicted in FIG. 4 shows that an optical fiber having two air holes has the unique capability of detecting transverse stresses.

Directional phrases used herein, such as, for example, upper, lower, left, right, vertical, horizontal, top, bottom, above, beneath, clockwise, counterclockwise and derivatives thereof, relate to the orientation of the elements shown in the drawings and are not limiting upon the claims unless expressly recited therein.

While specific embodiments of the disclosed and claimed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed and claimed concept which is to be given the full breadth of the claims appended and any and all equivalents thereof.

What is claimed is:

1. An optical fiber comprising:
an elongated core having an exterior surface;
a cladding substantially surrounding and in contact with said exterior surface of said core; and
said cladding defining a plurality of longitudinal air holes.

2. The optical fiber according to claim 1, wherein said plurality of longitudinal air holes extend substantially parallel to a longitudinal axis of said optical fiber.

3. The optical fiber according to claim 1, wherein said plurality of longitudinal air holes is positioned adjacent to said core.

4. The optical fiber according to claim 1, wherein at least one fiber Bragg grating is formed into said exterior surface of said core.

5. An optical fiber comprising:
an elongated core having an exterior surface;
a cladding having an interior surface and an exterior surface substantially surrounding and in contact with said exterior surface of said core, said cladding defining a plurality of longitudinal air holes;
a buffer having an interior surface and an exterior surface substantially surrounding and in contract with said exterior surface of said cladding; and
a jacket, having an interior surface and an exterior surface substantially surrounding and in contact with said exterior surface of said buffer.

6. The optical fiber according to claim 5, wherein said plurality of longitudinal air holes extend substantially parallel to a longitudinal axis of said optical fiber.

7. The optical fiber according to claim 5, wherein said plurality of longitudinal air holes is positioned substantially adjacent to said core.

8. The optical fiber according to claim 5, wherein at least one fiber Bragg grating is formed into said exterior surface of said core.

9. A method of making an optical fiber that is capable of measuring a transverse stress comprising:
providing an elongated core having an exterior surface;
surrounding said exterior surface of said core with a cladding having an interior surface and an exterior surface, said cladding defining a plurality of longitudinal air holes;
surrounding said exterior surface of said cladding with a buffer having an interior surface and an exterior surface; and
surrounding said exterior surface of said buffer with a jacket having an interior surface and an exterior surface.

10. The method of claim 7, said cladding being a cladding having a plurality of longitudinal air holes extending substantially parallel to a longitudinal axis of said optical fiber.

11. The method of claim 7, said cladding being a cladding having at least one air hole positioned adjacent to said core.

12. The method of claim 7, further comprising forming at least one fiber Bragg grating into said exterior surface of said core.

13. A method of detecting transverse stress in an optical fiber comprising:
providing said optical fiber, said optical fiber having an elongated core, substantially surrounding said core is a cladding defining at least a plurality of longitudinal air holes, substantially surrounding said cladding is a buffer, and substantially surrounding said buffer is a jacket;
coupling an ASE light source to said optical fiber;
coupling an OSA to said fiber;
transmitting light from said ASE to said OSA;
employing said transmitted light to determine said transverse stress.

14. An optical fiber structured to measure a 3-D stress distribution in a structure comprising:
an elongated core having an exterior surface;
a cladding having an interior surface and an exterior surface substantially surrounding and in contact with said exterior surface of said core, said cladding defining a plurality of longitudinal air holes;
a buffer having an interior surface and an exterior surface substantially surrounding and in contract with said exterior surface of said cladding; and
a jacket, having an interior surface and an exterior surface substantially surrounding and in contact with said exterior surface of said buffer;
whereby passing light from an ASE light source through said optical fiber will facilitate measurement of said 3-D stress.
